(19) United States
(12) Patent Application Publication
(10) Pub. No.: US 2013/0087570 A1
(43) Pub. Date: Apr. 11, 2013

(54) METHOD FOR PROVIDING AND TESTING STORAGE CONTAINMENT

(71) Applicants: Jahanguir Ekhtiar, Turlock, CA (US); David P. Harris, Waterford, CA (US); Thomas Lindquist, Ballico, CA (US)

(72) Inventors: Jahanguir Ekhtiar, Turlock, CA (US); David P. Harris, Waterford, CA (US); Thomas Lindquist, Ballico, CA (US)

(73) Assignee: Convault, Inc., Denair, CA (US)

(21) Appl. No.: 13/267,556

(22) Filed: Oct. 6, 2011

(51) Int. Cl. B65D 90/00; G01M 3/28

(52) U.S. Cl. 220/694; 73/40.5 R

(57) ABSTRACT

In various embodiments, systems and methods are provided for constructing and testing of a barrier providing secondary containment for aboveground storage tanks. Concrete storage containers can be manufactured with primary steel tanks and spill containment formed using an airtight tank wrap. Concrete storage containers can be manufactured with a barrier providing secondary containment to meet or exceed most current codes and standards commonly required for the storage of petroleum, flammable, combustible and other hazardous liquids. Such storage containers can include one or more thermal barriers that provide enhanced resistance when subjected to liquid-pool/furnace fire tests. Additionally, a concrete exterior acts as a thermal mass reducing temperature variations. The concrete exterior further provides a non-corrosive, durable exterior having increased vehicle-impact and projectile-impact resistance. Due to the method of construction in some embodiments, concrete storage containers are provided which give thermal/vehicle impact/projectile resistance while also meeting expectations in weight and buoyancy criteria.

### CROSS-REFERENCES TO RELATED APPLICATIONS

This application is related to U.S. patent application Ser. No. 08/171,241, now U.S. Pat. No. 5,372,772, which is a continuation of U.S. patent application Ser. No. 07/888,413, filed May 21, 1992, now abandoned, which is a continuation of U.S. patent application Ser. No. 07/541,004, filed Jun. 20, 1990, now abandoned, which is a continuation-in-part of U.S. patent application Ser. No. 07/298,548, filed Mar. 9, 1989, now U.S. Pat. No. 4,963,082, which is a division of U.S. patent application Ser. No. 07/118,919, filed Nov. 16, 1987, now U.S. Pat. No. 4,826,644, which is a continuation-in-part of U.S. patent application Ser. No. 06/936,205, filed Dec. 1, 1986, now abandoned, the disclosures of each are hereby incorporated by reference for all purposes.

### BACKGROUND OF THE INVENTION

There is a continuing interest in the safe containment of liquids, particularly gasoline and other fuels because of the vast amount of fuel presently stored in various localities. Other liquids used in industry, in addition to fuels, can be hazardous from an environmental standpoint, from a safety standpoint, or both.

It has become increasingly apparent that storage tanks (whether located underground or above ground) can and do leak, thus causing serious short-term and long-term problems. Therefore, many countries, state and federal governments, and other governmental organizations and localities have enacted statutes, rules, and regulations (mostly for underground fuel storage tanks) to ensure meeting adequate design and safety practices recommended by codes. For example, the National Fire Protection Agency (NFPA) in the National Fire Code or the International Code Council (ICC) in the International Fire Code proscribe standards and recommendations in the construction of storage tanks designated for fuel or hazardous storage, in the installation of storage tanks, and for scheduled maintenance and testing to determine if the tanks are leaking. In the case of underground tanks, it is an expensive process to inspect the storage tanks and test the earth surrounding the tanks for indications of leakage. If a leak is detected, the storage tanks can be drained and abandoned, dug up and removed, or repaired in place. These options alone are all quite expensive. Above ground storage tanks are favorable in this respect, yet no matter where a storage tank is placed, if the soil surrounding or underneath a leaking tank is contaminated, the soil must be removed which further increases the expense.

To aid in the prevention of leaks, a variety of secondary containment methods and apparatus have been devised. For example, double wall (dual containment) tanks have been used for both underground and above ground storage. The second wall of a double wall tank serves as secondary containment for at least the entire primary storage. The interstice between the two walls can therefore be easily monitored for leakage using a variety of conventional testing mechanisms. Yet, double wall tanks can fall short in providing benefits in areas such as thermal resistance, vehicle-impact resistance, and projectile-impact resistance when located above ground. Additionally, inspectors have seen an increase in the number of steel tanks which have significant damage due to water contamination in stored fuels leading to an invasion of microorganisms (e.g., microbially influenced corrosion (MIC)). The microorganisms can also damage the secondary containment of double wall steel tanks once the primary steel tank has been breached.

ConVault, of Denair, Calif., specializes in the construction of above ground storage tanks that are a proven solution for one or more of these problems. ConVault developed a breakthrough idea of constructing a tank that does not have the costly underground tank's leak monitoring system and contamination problem and at the same time has overcome at least some of the problems associated with the unprotected above ground steel tanks. Because of unique monolithic concrete construction features, above ground tanks manufactured by ConVault provide at least two (2) hours of fire protection, vehicle impact resistance, and ballistic resistance proven by tests carried out by the Underwriters Laboratories of USA (UL) and Canada (ULC).

The ConVault tank construction process consists of four main steps, namely 1) primary tank construction, 2) secondary containment, 3) encasing in concrete, and 4) coating and finishing. One aspect of meeting adequate design and safety practices recommended by the National Fire Protection Agency (NFPA) in the National Fire Code or the International Code Council (ICC) in the International Fire Code (IFC), for example, is the testing of any secondary containment created in step 2 of ConVault's process or other processes used by ConVault's competitors. Most regulations require that testing shall be conducted using a test procedure that demonstrates that a system performs at least as well as it did upon initial installation. This general standard allows some flexibility in testing methods and encourages the development of new technology.

Accordingly, what is desired is to solve problems relating to providing and testing of a barrier providing secondary containment for aboveground storage tanks, some of which may be discussed herein. Additionally, what is desired is to reduce drawbacks relating to providing and testing of a barrier providing secondary containment for aboveground storage tanks, some of which may be discussed herein.

### BRIEF SUMMARY OF THE INVENTION

The following portion of this disclosure presents a simplified summary of one or more innovations, embodiments, and/or examples found within this disclosure for at least the purpose of providing a basic understanding of the subject matter. This summary does not attempt to provide an extensive overview of any particular embodiment or example. Additionally, this summary is not intended to identify key/critical elements of an embodiment or example or to delineate the scope of the subject matter of this disclosure. Accordingly, one purpose of this summary may be to present some innovations, embodiments, and/or examples found within this disclosure in a simplified form as a prelude to a more detailed description presented later.

In various embodiments, systems and methods are provided for constructing and testing of a barrier providing secondary containment for aboveground storage tanks. Concrete storage containers can be manufactured with primary steel tanks and spill containment formed using an airtight tank wrap. The manufactured storage containers can meet or exceed most current codes and standards commonly required for the storage of petroleum, flammable, combustible, and other hazardous liquids.

In various embodiments, a method for providing and testing secondary containment of storage containers includes providing a primary tank having at least an interior and at least an assembly configured to provide communication (e.g., of gases or liquids) with a primary containment area associated with the interior of the primary tank. At least a portion of the primary tank is covered with a tank wrap to create a secondary containment area between an exterior surface of the primary tank and at least one of a first layer and a second layer of the tank wrap. The first layer and the second layer of the tank wrap can be configured to create a tertiary containment area between the first layer and the second layer. The tank wrap can also include an assembly configured to provide communication (e.g., of gases or liquids) with the tertiary containment area between the first layer and the second layer.

An assembly is also provided that is configured to provide communication (e.g., of gases or liquids) with the secondary containment area that exists between the exterior surface of the primary tank and at least one of the first layer and the second layer of the tank wrap. For example, the assembly may be configured for leak detection within the secondary containment area. Integrity of the secondary containment area can be checked and tested by performing at least one of a plurality of separate checking steps for example using the assembly configured to provide communication with the tertiary containment area between the first layer and the second layer of the tank wrap. A first checking step may include either vacuum testing the tank wrap or pressure testing the tank wrap subsequent to covering any portion of the primary tank with the tank wrap. A second checking step can include either vacuum testing the tank wrap or pressure testing the tank wrap subsequent to encasing the primary tank and the tank wrap in one or more layers of concrete.

In some embodiments, integrity of the tank wrap can be checked by performing at least one of a plurality of checking steps including vacuum testing and/or pressure testing the tank wrap for leakage prior to covering any a portion of the primary tank with the tank wrap. The tank wrap may be constructed from a variety of semi-rigid materials. For example, the tank wrap maybe constructed in response to welding at least two sheets of a polyethylene material to create an airtight polyethylene mat. In another embodiment, the tank wrap may be constructed in response to forming at least two sheets of rubber to create an airtight rubber mat.

In further embodiments, the tank wrap may be constructed in response to enclosing a material between the first layer and the second layer of the tank wrap. The material may be configured to enhance communication within the tertiary containment area between the first layer and the second layer of the tank wrap. Alternatively, the tank wrap may be constructed wherein at least a portion of at least one of the first layer and the second layer of the tank wrap is deformed to enhance communication within the tertiary containment area between the first layer and the second layer of the tank wrap. In one aspect, at least one of the first layer and the second layer of the tank wrap may be deformed to include one or more dimples. In another aspect, at least one of the first layer and the second layer of the tank wrap may be deformed to include one or more ridges. These deformations may provide enhanced communication of gases or liquids with the tertiary containment area between the first layer and the second layer of the tank wrap.

In further embodiments, at least a portion of the primary tank can be covered with a material configured to thermally insulate the primary tank prior to covering any portion of the primary tank with the tank wrap. The primary tank and the tank wrap can further be encased in one or more layers of concrete.

In at least one embodiment, a storage container includes a tank wrap having at least a first layer and a second layer. The first layer and the second layer of the tank wrap are configured to create a containment area between the first layer and the second layer. The tank wrap further includes a tank wrap testing assembly configured to provide air communication with the containment area between the first layer and the second layer. The storage container further includes a primary tank having at least an interior and including a primary tank assembly configured to provide liquid communication with a containment area associated with the interior of the primary tank. At least a portion of the primary tank is covered with the tank wrap to create a containment area between an exterior surface of the primary tank and at least one of the first layer and the second layer of the tank wrap. The storage container includes a testing device configured to check integrity of the containment area between the exterior surface of the primary tank and one of the first layer and the second layer of the tank wrap in response to performing at least one of a plurality of checks. A first check includes a vacuum test of the tank wrap using the tank wrap testing assembly. A second check comprising a pressure test of the tank wrap using the tank wrap testing assembly.

In at least one embodiment, system for testing secondary containment comprising a inner tank having at least an interior and including at least a first assembly configured to provide liquid communication with a primary containment area associated with the interior of the inner tank. An airtight poly mat covers at least a portion of the inner tank to create a secondary containment area between an exterior surface of the inner tank and at least one of a first poly layer and a second poly layer of the airtight poly mat. The airtight poly mat including a means for testing integrity of a tertiary containment area between the first poly layer and the second poly layer. The system further includes means for testing integrity of the secondary containment area by performing at least one of a plurality of separate checks using means for vacuum testing the airtight poly mat or means for pressure testing the airtight poly mat using the means for testing integrity of the tertiary containment area subsequent to covering any portion of the primary tank with the airtight poly mat and means for vacuum testing the airtight poly mat or means for pressure testing the airtight poly mat using the means for testing integrity of the tertiary containment area subsequent to encasing the primary tank and the tank wrap in one or more layers of concrete.

A further understanding of the nature of and equivalents to the subject matter of this disclosure (as well as any inherent or express advantages and improvements provided) should be realized in addition to the above section by reference to the remaining portions of this disclosure, any accompanying drawings, and the claims.

### BRIEF DESCRIPTION OF THE DRAWINGS

In order to reasonably describe and illustrate those innovations, embodiments, and/or examples found within this disclosure, reference may be made to one or more accompanying drawings. The additional details or examples used to describe the one or more accompanying drawings should not be considered as limitations to the scope of any of the claimed inventions, any of the presently described embodiments and/or examples, or the presently understood best mode of any innovations presented within this disclosure.

FIG. 1 is a side cross-sectional view showing a storage container in one embodiment according to the present invention.

FIG. 2 is an exploded cross-sectional view the storage container of FIG. 1.

FIG. 3 is a flowchart of a method for providing and testing storage containment in one embodiment according to the present invention.

FIG. 4 is a flowchart of a method for creating a tank wrap for container of FIG. 1 in one embodiment according to the present invention.

FIG. 5 shows a testing assembly for a tank wrap of the storage container of FIG. 1 in one embodiment according to the present invention allowing integrity checks prior to encasing in a layer of concrete.

FIG. 6 shows a testing assembly for a tank wrap of the storage container of FIG. 1 in one embodiment according to the present invention allowing integrity checks subsequent to encasing in a layer of concrete.

FIGS. 7 and 8 are views of the testing assembly of FIG. 5 or the testing assembly of FIG. 6 with portions broken away to show the use of a webbing material to enhance communication in some embodiments.

FIG. 9A is a view of at least one layer of a tank wrap for the storage container of FIG. 1 showing one or more dimple deformations to enhance communication in one embodiment.

FIG. 9B is a view of at least one layer of a tank wrap for the storage container of FIG. 1 showing one or more ridges or corrugation deformations to enhance communication in one embodiment.

FIG. 10 is a view of preparations for wrapping the storage container of FIG. 1 in one embodiment showing webbing material to enhance communication in some embodiments to a detection tube.

FIGS. 11A and 11B show wrapping the storage container of FIG. 1 in one embodiment according to the present invention.

FIG. 12 shows the storage container of FIG. 1 after wrapping in one embodiment according to the present invention.

FIG. 13 is a cross-sectional view of the storage container of FIG. 1 after wrapping in one embodiment according to the present invention.

### DETAILED DESCRIPTION OF THE INVENTION

In today's political and social environment, safety and security has become a top concern with facility owners storing petroleum, flammable, combustible, and other hazardous liquids. Interest in the preservation of our environment has prompted all levels of government to enact rules and regulations for the installation, operation and removal of underground fuel storage tanks. Often, these rules and regulations require adherence to a variety of codes and standards developed by non-governmental organizations, such as the NFPA and the ICC.

In various embodiments, systems and methods are provided for constructing and testing of a barrier providing secondary containment for aboveground storage tanks. Concrete storage containers can be manufactured with primary steel tanks and spill containment formed using an airtight tank wrap. The manufactured storage containers can meet or exceed most current codes and standards commonly required for the storage of petroleum, flammable, combustible and other hazardous liquids. Such storage containers or storage vaults can further include one or more thermal barriers that provide enhanced resistance when subjected to liquid-pool/furnace fire tests. Additionally, a concrete exterior acts as a thermal mass reducing temperature variations. The concrete exterior further provides a non-corrosive, durable exterior having increased vehicle-impact and projectile-impact resistance. Due to the method of construction in some embodiments, concrete storage containers are provided which give thermal/vehicle impact/projectile resistance while also meeting weight and buoyancy criteria for use in potential flood plains without the risk of floating away.

In several aspects, embodiments include an airtight tank wrap that provides at least a direct benefit of a barrier for spill containment as secondary containment for aboveground storage tanks. Embodiments of the airtight tank wrap may include materials that provide resistance to microbial invasion further limiting the likelihood of a leak from secondary containment. Specifically, by providing nonmetallic secondary containment instead of steel, damage to the secondary containment is prevented by MIC. Furthermore, embodiments of the airtight tank wrap maintain the feature of a testable barrier for secondary containment for aboveground storage tanks.

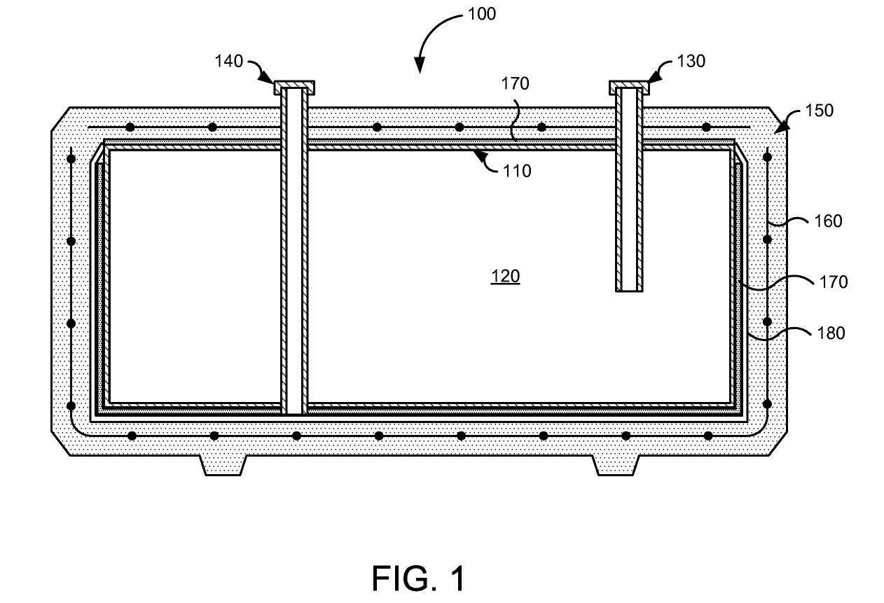

FIG. 1 is a side cross-sectional view showing storage container 100 in one embodiment according to the present invention. Storage container 100 is shown to include inner tank 110. Inner tank 110 may be constructed of one or more metals, composites, plastics, rubbers, concrete, or other materials and combinations suitable for the storage and containment of specific liquids. Inner tank 110 is configured with an interior that forms primary containment area 120. Inner tank 110 may include one or more reinforcements or other structural elements (not shown) suitable to maintain a predetermined volume or capacity within primary containment area 120. In one embodiment, inner tank 110 includes a steel tank rectangular in shape that has continuous welds on all exterior seams. The steel tank may be manufactured in accordance with Underwriters Laboratories (UL) listing requirements and UL Standard 142. Inner tank 110 may also be configured to be pressure tested (e.g., at 5 psig for 24 to 48 hours) to assess the integrity of inner tank 110 for providing primary containment area 120.

Inner tank 110 may further include additional structures, openings, or features (some not shown) suitable for the introduction of liquids into primary containment area 120 or the evacuation of liquids from primary containment area 120. In this example, conduit 130 represents any variety of pipes, tubes, or other structures (e.g., conventional fill and/or vent apparatuses) that may extend into the interior of inner tank 110. In another example, inner tank may incorporate an “emergency vent” system as per National Fire Protection Agency (NFPA) 30 Code requirements. Inner tank 110 may further include additional structures, openings, byways, or features (some not shown) suitable for physical checkup and monitoring of other areas of storage container 100. For example, inner tank 110 may have one or more thru-tank leak detector tubes to allow for physical checkup and monitoring capability between primary containment area 120 and any additional containment areas. In this example, conduit 140 represents any variety of pipes, tubes, byways, or other structures that permit leaks from inner tank 110 to be monitored (e.g., as any leaking liquid would collect in the interstice between an outer layer of inner tank 110 and an inner layer of outer tank 150).

Storage container 100 is further shown to include inner tank 110 within outer tank 150. Outer tank 150 may be constructed of one or more metals, composites, plastics, rubbers, concrete, or other materials and combinations suitable for enclosing, encasing, or entombing inner tank 110. Outer tank 150 may include one or more reinforcements or other structural elements suitable to maintain the integrity of either inner tank 110 or outer tank 150. In various embodiments, outer tank 150 is formed by one or more concrete layers strengthened by rebar 160. In at least one embodiment, outer tank 150 includes at least six inches of monolithic reinforced concrete. Outer tank 150 may include bottom supports which raise the bottom of storage container 100 above a support surface to create an inspection region between the bottom of storage container 100 and the support surface.

In some aspects, outer tank 150 may further include additional structures, openings, or features (some not shown) providing access to structures, openings, or features of inner tank 110 that facilitate the introduction of liquids into primary containment area 120 or the evacuation of liquids from primary containment area 120. Outer tank 150 may include additional structures, openings, or features (some not shown) providing access to structures, openings, or features of inner tank 110 that facilitate leak detection and/or the testing of any additional containment areas. In further aspects, outer tank 150 may be configured to accommodate supplemental containment areas and structures, insulators and thermal barriers, and the like, between an outer surface of inner tank 110 and an inner surface of outer tank 150.

In FIG. 1, inner tank 110 is partially or totally surrounded by spacer layer 170 in the space between the outer surface of inner tank 110 and the inner surface of outer tank 150. Spacer layer 170 may include empty space, voids or cavities, one or more insulating layers, one or more thermal barriers, one or more fire retarders, or the like. Some examples of insulating layers and thermal barriers can include materials such as Styrofoam, polystyrene, or the like. In at least one embodiment, spacer layer 170 includes a minimum of ¼″ thick (6.4 mm) Styrofoam insulation panels covering all or part of inner tank 110. Spacer layer 170 may further include reinforcing structures, conduits, pathways, or the like and other materials or structures that facilitate the detection of liquids leaking from inner tank 110.

In some aspects, spacer layer 170 performs a variety of functions. Spacer layer 170 may include one or more materials that act as thermal insulator so as to insulate the contents of inner tank 110 from external heat sources, such as fires. In addition, spacer layer 170 may include one or more materials that help to keep the contents of inner tank 110 at a more uniform temperature. As a result, spacer layer 170 helps to reduce vapor pressures within inner tank 110 making the storage of liquids safer and more environmentally friendly by reducing the potential for vapor leaks to the atmosphere. In addition, spacer layer 170 may include one or more materials specifically chosen so that they melt or otherwise liquefy when a liquid within inner tank 110 contacts the material. In embodiments where inner tank 110 holds a liquid hydrocarbon fuel, such as gasoline or diesel fuel, by choosing one or more materials for spacer layer 170 to be made of Styrofoam or polystyrene, for example, if the liquid within inner tank 110 leaks through to spacer layer 170, any Styrofoam or polystyrene in spacer layer 170 melts or dissolves thus creating an open region permitting the leaked hydrocarbon to collect at one or more liquid collection regions, such as near conduit 140. This permits the leak to be quickly noticed through conduit 140 using conventional methods.

In various embodiments, inner tank 110 and spacer layer 170 are further partially or totally surrounded by tank wrap 180 in the space between the outer surface of inner tank 110 and the inner surface of outer tank 150. Tank wrap 180 is any set of materials, mats, envelops, covers, pads, or the like that includes at least two or more layers. In various embodiments, tank wrap 180 is preferably constructed by a plurality of liquid impervious sheets of polyethylene, either high density (HDPE) or low density (LDPE). In at least one aspect, tank wrap 180 is configured to contain any leaks from primary containment area 120 of inner tank 110. Specifically, tank wrap 180 creates a secondary containment area in the interstice between an outer surface of inner tank 110 and one of the layers of tank wrap 180. In another aspect, tank wrap 180 is configured to further contain any leaks between at least two or more of a plurality of layers of tank wrap 180. Specifically, at least two or more layers of tank wrap 180 create a tertiary containment area in the interstice between the layers.

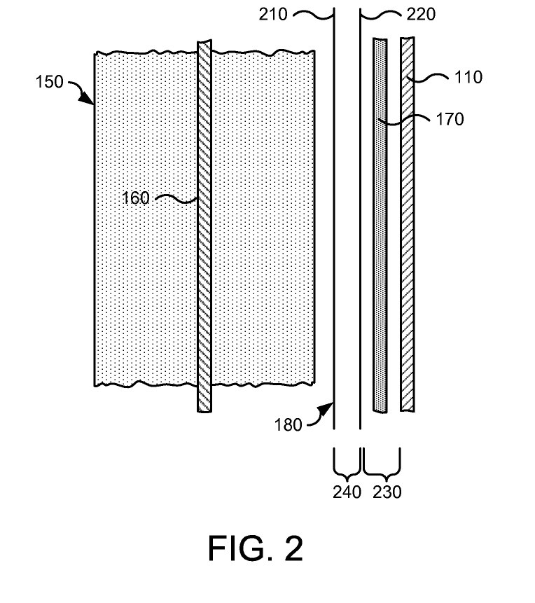

FIG. 2 is an exploded cross-sectional view of storage container 100 of FIG. 1. In this example, FIG. 2 illustrates that in a portion of the left wall of storage container 100, tank wrap 180 includes at least two or more layers, e.g. layer 210 and layer 220. Layer 210 is configured to have at least one surface facing an interior surface of outer tank 150. Layer 220 is configured to have at least one surface facing an outer surface of inner tank 110. In this example, layer 220 is configured with an outer surface facing inner tank 110 with spacer layer 170 in-between to form secondary containment area 230. In one aspect, at least layer 220 may be securely fixed to inner tank 110 to configure secondary containment area 230 as sealed, for example, to be at least airtight, watertight, or liquid proof.

As discussed above, one or both of layers 210 and 220 may be constructed of LDPE, HDPE, rubber, other plastics, and the like, or combinations thereof. In various embodiments, tank wrap 180 itself is configured to be sealed or to be at least airtight, watertight, or liquid proof. In one aspect, layers 210 and 220 may be molded, welded, or otherwise secured together to form tertiary containment area 240. For example, layers 210 and 220 can form tertiary containment area 240 between themselves. Prior to securing together layers 210 and 220, one or more testing mechanisms or devices may be affixed to at least one of layers 210 and 220 that facilitate checking (either directly or indirectly) the integrity of at least secondary containment area 230 during various stages of the construction of storage container 100.

Storage container 100 thus includes at least three containment areas. Primary containment area 120 is provided within the interior of inner tank 110 and serves as the main storage area for a desired material, such as liquids or gases. Secondary containment area 230 is provided between at least one layer of tank wrap 180 and an outer surface of inner tank 110. As discussed further below, tank wrap 180 may be configured to allow for testing of secondary containment area 230 during various stages of the construction of storage container 100 and post-construction. Testing may include a variety of mechanisms (e.g., vacuum and pressure). Tank wrap 180 further provides for testing of tertiary containment area 240 both during various stages of the construction of storage container 100 and post-construction.

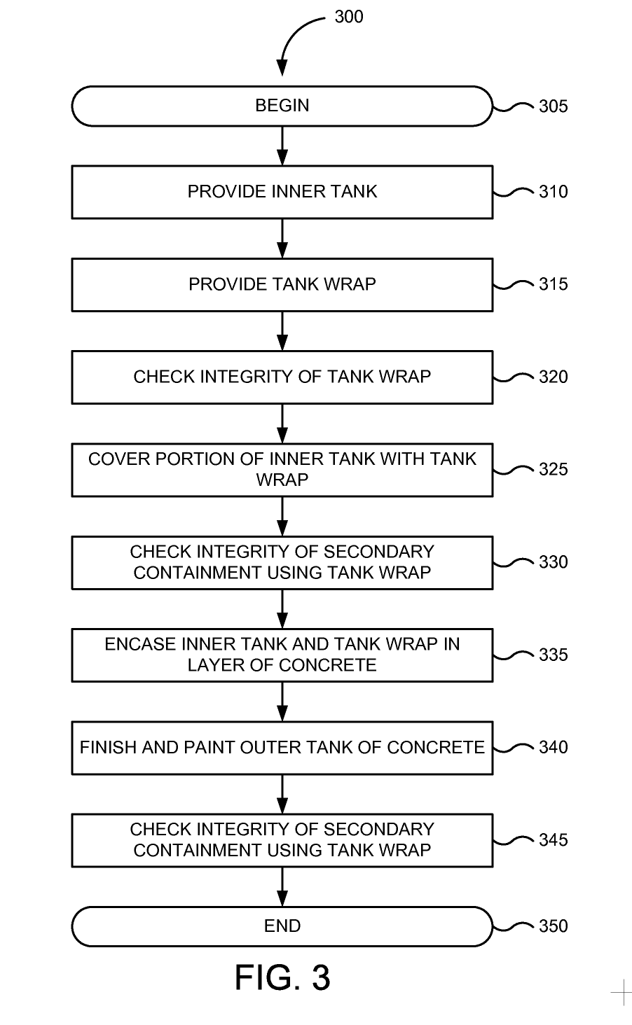

FIG. 3 is a flowchart of method 300 for providing and testing storage containment in one embodiment according to the present invention. Method 300 begins in step 305. First, in step 310, an inner tank (e.g., inner tank 110) is provided. An appropriate primary tank or inner tank is typically selected based on predetermined fluid to be stored therein. An appropriate primary tank or inner tank may also be selected for structure, environmental, or other reasons. As discussed above, the inner tank may be prepared with a number of conduits, attachments, communication pipes, etc. Additionally, the inner tank may be prepared with a number of insulating materials, thermal barriers, leak detection mechanism, or the like before proceeding to the next step.

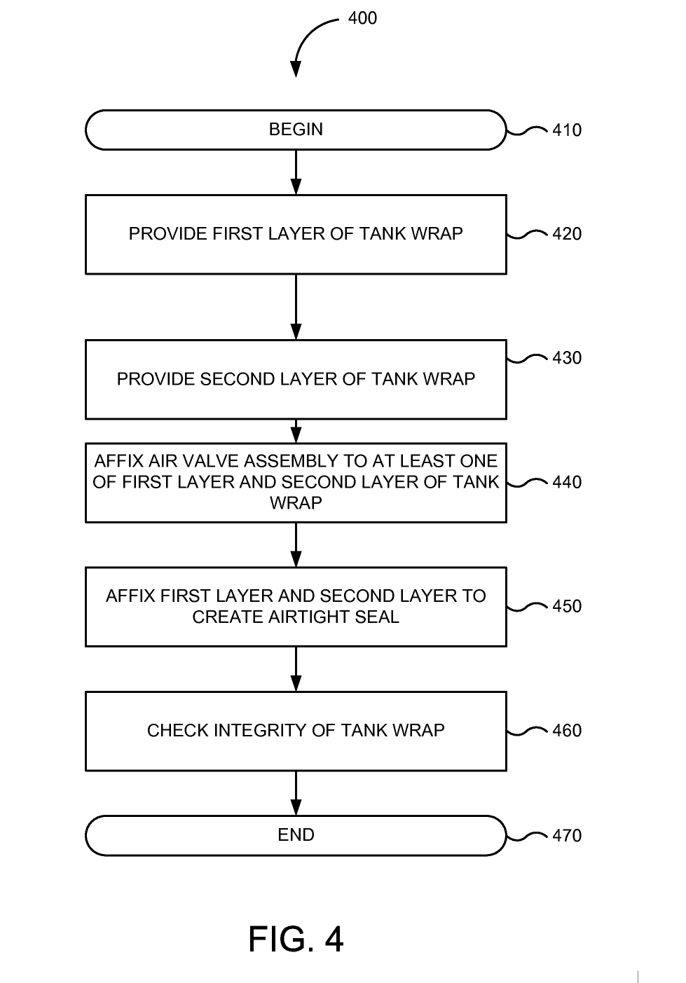

In step 315, a tank wrap (e.g., tank wrap 180) is provided. As discussed above, the tank wrap is typically an airtight mat that has a plurality of liquid impervious layers, such as HPDE. One method for constructing tank wrap 180 is discussed further below with respect to FIG. 4. Tank wrap 180 directly provides for at least one containment area in combination with inner tank 110 and at least one containment area by itself. Tank wrap 180 further may be configured for feasibility in testing integrity of each of these additional containment areas both during and after the construction process of storage container 100.

For example, in step 320, integrity of the tank wrap is tested. At this corresponding stage in the construction of storage container 100, for example, it may not be practical to use air pressure to test tank wrap 180 because moldings or welds applied to layers of tank wrap 180 to create an airtight mat may not support complete inflation or ballooning. Thus, vacuum testing is more practical. In one aspect, tank wrap 180 may be manufactured on site of the construction of storage container 100 and may be tested after manufacturing. Additionally, tank wrap 180 may be manufactured off-site and shipped to the location where storage container 100 is to be manufactured. Tank wrap 180 may be tested after manufacturing and also tested after shipping.

In some embodiments, a vacuum test checking integrity of tank wrap 180 may include placing tertiary containment area 240 into a specific vacuum or near vacuum state (e.g., 10 inches Mercury or more) for a predetermined length of time. In some embodiments, a pressure test checking integrity of tank wrap 180 may include placing tertiary containment area 240 into a predetermined pressure state for a predetermined length of time.

In step 325, a portion of the container is covered with the tank wrap. For example, inner tank 110 of FIG. 1 may be placed centered atop tank wrap 180. One or more portions of tank wrap 180 may be wrapped over and around inner tank 110 (e.g., over spacer layer 170) to cover or encase all or part of inner tank 110. As discussed further below, one or more portions of tank wrap 180 may be gathered or folded over each side of inner tank 110 and at or at least near the top edge of each side of inner tank 110. The one or more portions may be affixed to inner tank 110 (and to themselves) so as to create a barrier sealing secondary containment area 230. Additionally, to prevent water seeping into secondary containment area 230 through any folded portions of tank wrap 180, the tops of any folded portions of tank wrap 180 can be sealed, for example with a special tape.

In step 330, integrity of the secondary containment is tested using the tank wrap. At this stage of construction of storage container 100, tank wrap 180 may be tested for integrity either by vacuum or pressure tests. This can serve two purposes. One, the integrity of tank wrap 180 is directly tested either using a vacuum test or pressure test, for example, to observe functioning of tertiary container area 240. Secondly, the integrity of tank wrap 180 directly tests functioning of secondary containment area 230. Accordingly, multiple containment areas of storage container 100 can be tested for integrity independently, during construction and post construction.

In step 335, the inner tank and the tank wrap are encased in a layer of concrete. For example, a concrete form assembly may be used to entomb inner tank 110 and tank wrap 180 as a unit combination in one or more layers of concrete as outer tank 150. In step 340, the outer tank is finished and painted. In step 345, integrity of the secondary containment is again tested using the tank wrap. Again, this can serve the dual purposes of directly testing to observe functioning of secondary containment area 230 and tertiary container area 240. In various embodiments, step 345 may occur before the finishing and paining in step 340 or both before and after. Accordingly, multiple containment areas of storage container 100 can be tested for integrity independently, during construction and post construction. FIG. 3 ends in step 350.

FIG. 4 is a flowchart of method 400 for creating tank wrap 180 for storage container 100 of FIG. 1 in one embodiment according to the present invention. Method 400 begins in step 410.

In step 420, a first layer of a tank wrap is provided. The first layer of a tank wrap may be formed by High Density Polyethylene (HDPE), Low Density Polyethylene (LDPE), rubber, and other suitable materials for liquid storage containment. In step 430, a second layer of the tank wrap is provided. The second layer also may be formed by High Density Polyethylene (HDPE), Low Density Polyethylene (LDPE), rubber, and other suitable materials for liquid storage containment. The second layer may be the same as or different from the first layer.

In step 440, an air valve assembly is affixed to at least one of the first layer and the second layer. By affixing an air valve assembly to at least one of the first layer and the second layer, in at least one aspect, integrity of the tank wrap may be tested independently during one or several separate independent integrity checks performed during the construction process of a storage container or container. Additionally, integrity of other containment areas directly formed by the tank wrap (e.g., secondary containment area 230 of FIG. 2) or indirectly affected by presence of the tank wrap (e.g., primary containment area 120) may be tested both during construction and post-construction when in operation.

In step 450, the first layer and the second layer are affixed to create an airtight seal. For example, the first layer and the second layer may be welded together along and around all sides to create an airtight mat. In other embodiments, one or more adhesives may be used to affix each layer to the other to create an airtight mat. In still further embodiments, a material may be integrally molded, blown, or shaped in to the first layer and the second layer to create an airtight mat.

In step 460, integrity of the tank wrap is tested. At this stage of construction of storage container 100, tank wrap 180 may be tested for integrity either by vacuum or pressure tests. As discussed above, this can serve two purposes for testing a barrier providing secondary containment for aboveground storage tanks. One, the integrity of tank wrap 180 is directly tested either using a vacuum test or pressure test, for example, to observe functioning of tertiary container area 240. Secondly, the integrity of tank wrap 180 directly tests functioning of secondary containment area 230. FIG. 4 ends in step 470.

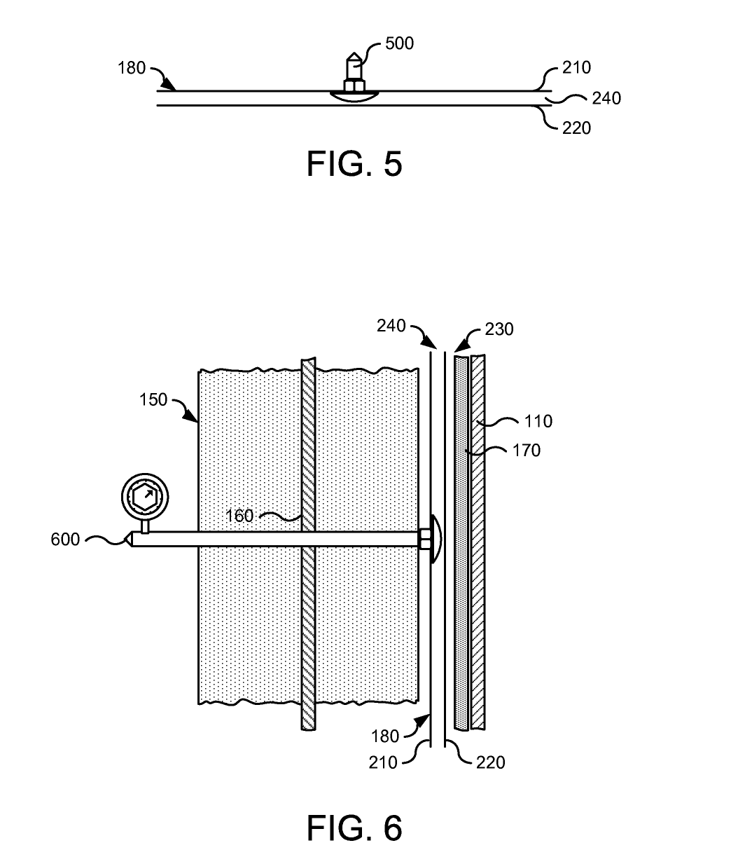

FIG. 5 shows testing assembly 500 for tank wrap 180 of storage container 100 of FIG. 1 in one embodiment according to the present invention allowing integrity checks prior to encasing in a layer of concrete. In this example, testing assembly 500 includes an air valve shown situated in layer 210 of tank wrap 180. Testing assembly 500 may include flow devices configured to allow unidirectional or bidirectional communication of air. Testing assembly 500 may further include one or more release mechanisms and the like. Testing assembly 500 may also include one or more conduits, hoses, or fittings to allow testing using conventional methods during the separate independent integrity checks at different stages of construction of storage container 100.

FIG. 6 shows testing assembly 600 for tank wrap 180 of storage container 100 of FIG. 1 in one embodiment according to the present invention allowing integrity checks subsequent to encasing in a layer of concrete. In this example, testing assembly 500 includes an air valve situated in layer 210 of tank wrap 180. Testing assembly 600 further may include one or more air hoses or air fittings to allow testing using conventional methods during the separate independent integrity checks after construction of storage container 100. For example, testing assembly 600 may include one or more conduits, tubes, hoses, gauges, meters, etc. for a desired testing process or procedure.

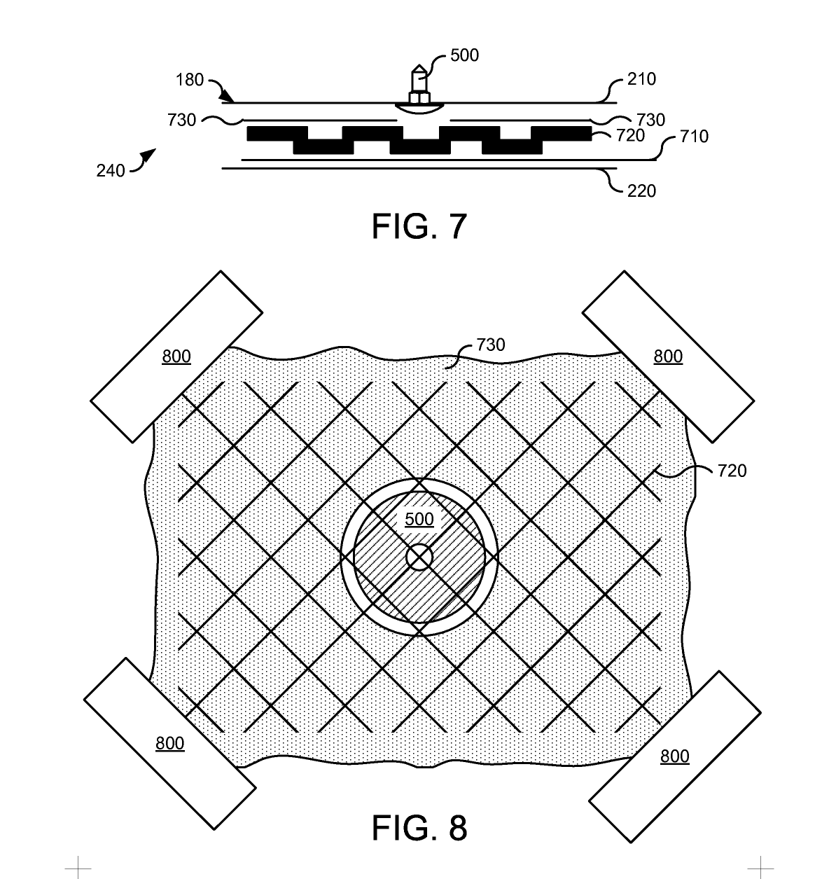

FIGS. 7 and 8 are views of testing assembly 500 of FIG. 5 or testing assembly 600 of FIG. 6 with portions broken away to show the use of a webbing material to enhance communication in some embodiments. Prior to affixing layer 210 and layer 220 of tank wrap 180, layer 710 is placed in-between layers 210 and 220. Layer 710 is configured to enhance air communication between layers 210 and 220. Layer 710 may include geosynthetics, such as geonets or geogrids, bird nets, or other materials that enhance air communication within tertiary containment area 240. In addition, layer 720 may be placed between layer 710 and layer 730. Layer 720 is configured to support testing assembly 500 or 600 and to enhance air communication. Layer 720 may include heavier materials than layer 710, such as an HDPE mesh. Layer 730 may be limited to a predetermined area surrounding testing assembly 500 or 600 and may include geosynthetics, such as geonets or geogrids, bird nets, or other materials that enhance air communication within tertiary containment area 240. Layer 730 may be affixed to layer 210 using one or more adhesives 800.

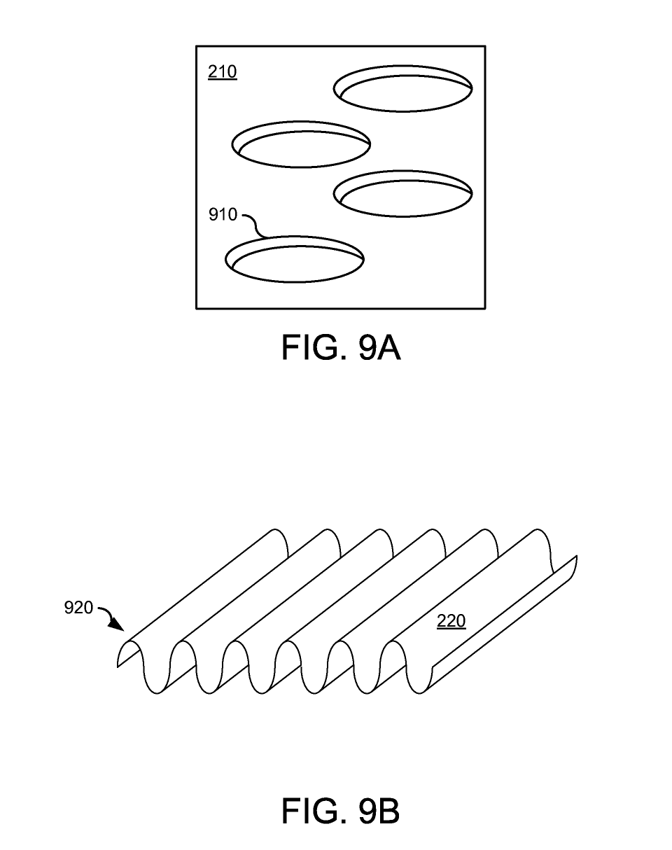

FIG. 9A is a view of at least one layer of tank wrap 180 for storage container 100 of FIG. 1 showing one or more dimple deformations to enhance communication in one embodiment. In this example, layer 210 is deformed to include one or more dimples 910. Dimples 910 may be formed using conventional techniques, such as injection molding, film molding, thermoforming, extrusion, stamping, and the like. Dimples 910 are configure to enhance air communication within tertiary containment area 240 during vacuum or pressure testing. Specifically, some materials may collapse on themselves during integrity testing such that pockets of air may be trapped. Dimples 910 prevent such collapses and allow the free flow of air. Other forms of deformations are envisioned that enhance air communication or mitigate local material collapse.

FIG. 9B is a view of at least one layer of tank wrap 180 for storage container 100 of FIG. 1 showing one or more ridges or corrugation deformations to enhance communication in one embodiment. In this example, layer 220 is deformed to include one or more ridges 920. Ridges 920 are configure to enhance air communication within tertiary containment area 240 during vacuum or pressure testing. Specifically, ridges 920 form a complete or partial corrugation of layer 220 to prevent collapse and allow the free flow of air. Ridges 920 may be formed using conventional techniques, such as injection molding, film molding, thermoforming, extrusion, stamping, and the like.

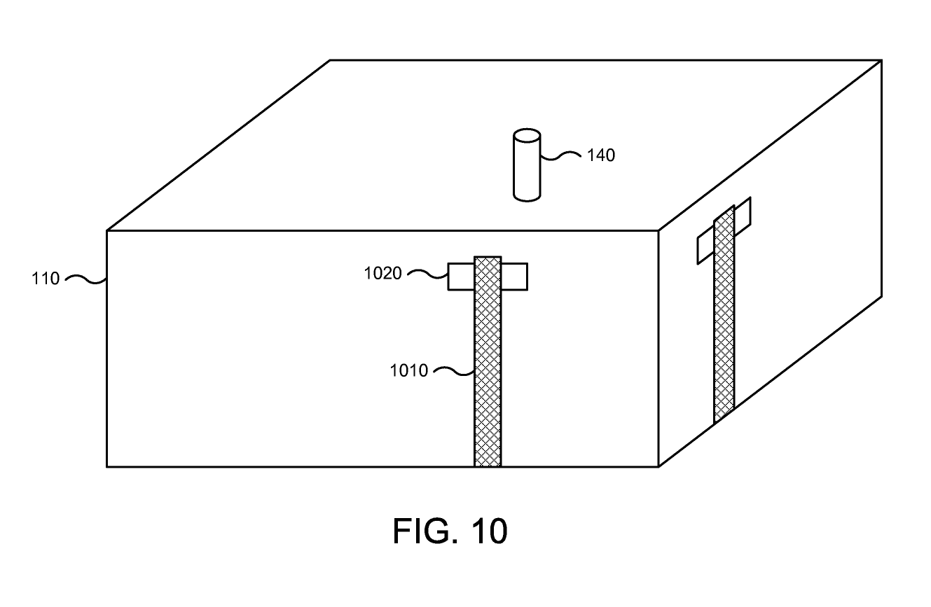

FIG. 10 is a view of preparations for wrapping storage container 100 of FIG. 1 in one embodiment showing webbing material to enhance communication in some embodiments to a detection tube. In this example, two bands of webbing material are affixed on inner tank 110 crossing under the bottom of inner tank 110 and at the centerline of conduit 140. The ends of each band of the webbing material are affixed to a side of inner tank 110. For example, band 1010 may be affixed to the side of inner tank 110 using adhesive 1020. Band 1010 may include geosynthetics, such as geonets or geogrids, bird nets, or other materials that enhance communication of any material stored in inner tank 110 toward the centerline of conduit 140. Adhesive 1020 may include glues, epoxies, tapes (e.g., double sided), and the like and other mechanical fixation means.

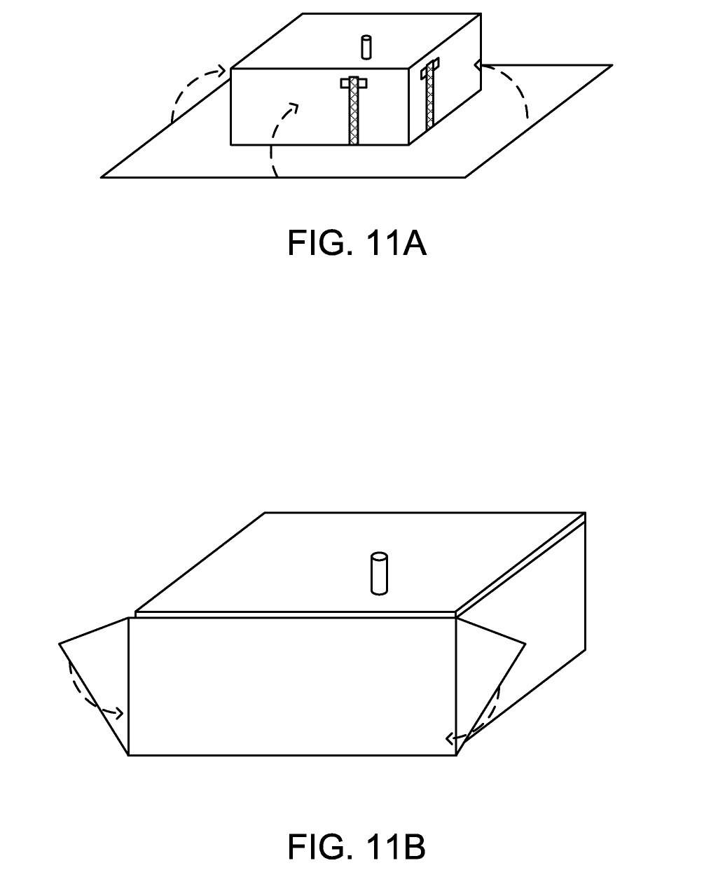

FIGS. 11A and 11B show wrapping storage container 100 of FIG. 1 in one embodiment according to the present invention. In FIG. 11A, inner tank 110 is placed on tank wrap 180. Inner tank 110 preferably is centered on tank wrap 180. Before wrapping, inner tank 110 may then be covered in Styrofoam, polystyrene, etc. for spacer layer 170. Tank wrap 180 is then wrapped around the walls and sides of inner tank 110. For example, as shown in FIG. 11A, tank wrap 180 is sized such that each of the four edges of tank wrap 180 are pulled up and affixed to the closest wall and side of inner tank 110. Tank wrap 180 may be affixed to the walls and sides of inner tank 110 using one or more adhesives, tapes, or other mechanical means.

In one embodiment, double sided tape is used to create a continuous and uniform attachment. Tank wrap 180 is then lifted and stretched to remove any wrinkles. Then tank wrap 180 is affixed to the double sided tape. Tank wrap 180 may be rolled to make sure there is continuous and uniform attachment and to prevent any air gaps or any air bubble between tank wrap 180 and the double sided tape and between the double sided tape and inner tank 110.

In FIG. 11B, ends of tank wrap 180 are folded so that each end overlaps another on the same side of inner tank 110. The top of any folds may be taped or otherwise sealed to prevent water and other liquids from entering secondary containment area 230 and between folds of tank wrap 180. Accordingly, as tank wrap 180 is securely affixed to inner tank 110, secondary containment area 230 can become sealed allowing for integrity testing using, for example, vacuum and/or pressure tests through the testing of tank wrap 180.

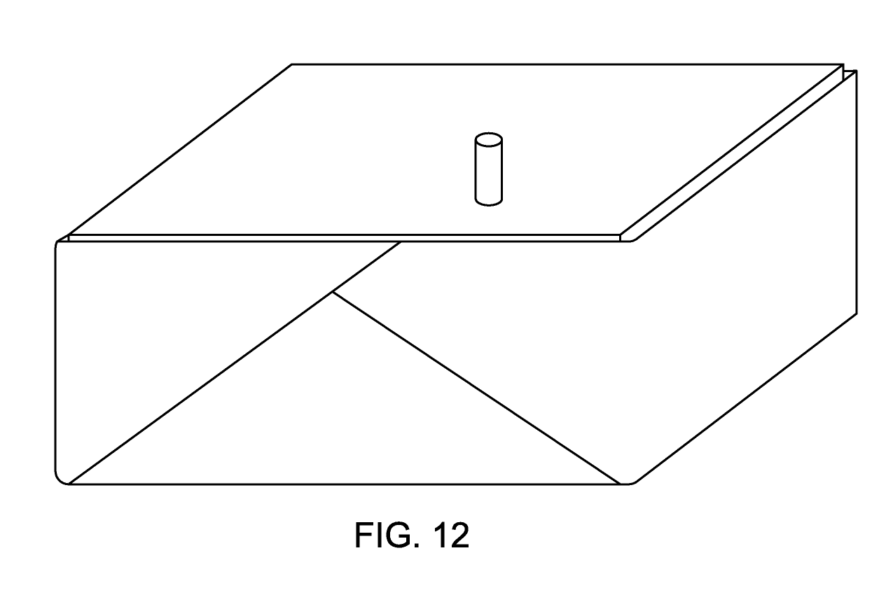

FIG. 12 shows storage container 100 of FIG. 1 after wrapping in one embodiment according to the present invention. In this example, inner tank 110 sits within tank wrap 180 as if wrapped like a present. The ends of tank wrap 180 have been folded and sealed to prevent liquids from entering secondary containment area 230. During construction, tank wrap 180 is preferably periodically tested using independent integrity checks of pressure and vacuum to check integrity of secondary containment area 230 and tertiary containment area 240.

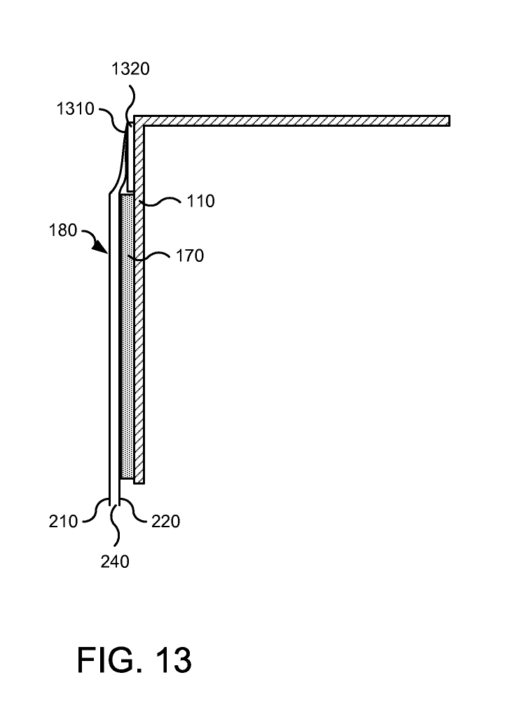

FIG. 13 is a cross-sectional view of storage container 100 of FIG. 1 after wrapping in one embodiment according to the present invention. In this example, tank wrap 180 is welded in area 1310 to create an airtight seal. Thus, tank wrap 180 directly creates tertiary containment area 240 between layers 210 and 220. Tank wrap 180 is further shown securely attached to inner tank 110 using double stick tape 1320. This process seals secondary containment area 230 as created by layer 220 of tank wrap 180 and an outer surface of inner tank 110.

Accordingly, storage container 100 made with inner tank 110 and tank wrap 180 can be used as a storage vessel to safely handle storage and containment of a variety of liquids, both above ground and below. For example, storage container 100 may be used as a vacuum storage vessel for waste motor oil or crank case motor oil. Storage container 100 incorporating a reinforced inner tank 110 could have a vacuum continuously applied to the inner interior of inner tank 110. A hose (not shown) would then be used to connect inner tank 110 to the oil, or other liquid, to be disposed of. The waste oil so collected could then periodically be removed from storage container 100 through the use of, for example, a mobile vacuum tank truck which can suck the waste oil directly out of the inner tank 110 and into the mobile tank. This would permit gasoline service stations, auto dealers, lube and oil change centers, among others, to safely and conveniently store the waste oil and grease in a safe, cost-effective manner. Even without creating a vacuum in the interior of inner tank 110, storage container 100 would still be useful for safely and inexpensively storing such waste oil, waste grease and other flowable materials, by pumping or pouring the waste material directly into storage container 100.

Storage container 100 may be situated above ground, partially buried, bunkered, or completely buried. Storage container 100 may be used for the storage of oil when its material and construction are compatible with the material stored and conditions of storage such as pressure and temperature. Storage container 100 provides a secondary containment area for the entire capacity of the largest single container. Additionally, storage container 100 provides testability of the secondary and tertiary containment areas throughout the construction process and after construction. Storage container 100 combines visual inspection with another testing technique of non-destructive testing.

The disclosed examples, implementations, and various embodiments of any one of those inventions whose teachings may be presented within this disclosure are merely illustrative to convey with reasonable clarity to those skilled in the art the teachings of this disclosure. As these implementations and embodiments may be described with reference to exemplary illustrations or specific figures, various modifications or adaptations of the methods and/or specific structures described can become apparent to those skilled in the art. All such modifications, adaptations, or variations that rely upon this disclosure and these teachings found herein, and through which the teachings have advanced the art, are to be considered within the scope of the one or more inventions whose teachings may be presented within this disclosure. Hence, the present descriptions and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

What is claimed is:

1. A method for providing and testing secondary containment of storage containers, the method comprising:
providing a primary tank having at least an interior and including at least a first assembly configured for communication with a primary containment area associated with the interior of the primary tank;
providing a second assembly configured for leak detection within a secondary containment area created between an exterior surface of the primary tank and at least one of a first layer and a second layer of a tank wrap;
covering a portion of the primary tank with the tank wrap to create the secondary containment area between the exterior surface of the primary tank and the at least one of the first layer and the second layer of the tank wrap; and
checking integrity of the secondary containment area using a third assembly configured to provide communication with a tertiary containment area created between the first layer and the second layer of the tank wrap by performing at least one of a plurality of separate checking steps,
a first checking step subsequent to covering a portion of the primary tank with the tank wrap comprising either vacuum testing the tank wrap or pressure testing the tank wrap, and
a second checking step subsequent to encasing the primary tank and the tank wrap in one or more layers of concrete comprising either vacuum testing the tank wrap or pressure testing the tank wrap.

2. The method of claim 1 further comprising:
checking integrity of the third containment area using the third assembly configured to provide communication with the tertiary containment area created between the first layer and the second layer of the tank wrap by performing at least one checking step prior to covering a portion of the primary tank with the tank wrap comprising either vacuum testing the tank wrap or pressure testing the tank wrap.

3. The method of claim 1 further comprising constructing the tank wrap in response to welding at least two sheets of a polyethylene material to create an airtight polyethylene mat.

4. The method of claim 1 further comprising constructing the tank wrap in response to forming at least two sheets of rubber to create an airtight rubber mat.

5. The method of claim 1 further comprising constructing the tank wrap in response to enclosing a material between the first layer and the second layer of the tank wrap, the material configured to enhance communication within the tertiary containment area between the first layer and the second layer of the tank wrap.

6. The method of claim 1 further comprising constructing the tank wrap wherein a portion of at least one of the first layer and the second layer of the tank wrap is deformed to enhance communication within the tertiary containment area between the first layer and the second layer of the tank wrap.

7. The method of claim 6 wherein the portion of at least one of the first layer and the second layer of the tank wrap is deformed to include one or more dimples.

8. The method of claim 6 wherein the portion of at least one of the first layer and the second layer of the tank wrap is deformed to include one or more ridges.

9. The method of claim 1 further comprising covering at least a portion of the primary tank with a material configured to thermally insulate the primary tank prior to covering a portion of the primary tank with the tank wrap.

10. The method of claim 1 further comprising encasing the primary tank and the tank wrap in one or more layers of concrete.

11. A storage container comprising:
a primary tank having at least an interior and including a first assembly configured to provide liquid communication with a primary containment area associated with the interior of the primary tank;
a second assembly configured for leak detection within a secondary containment area created in response to covering the primary tank with a tank wrap having a first layer and a second layer, the tank wrap configured to create a tertiary containment area between the first layer and the second layer;
a third assembly associated with at least one of the first layer and the second layer of the tank wrap, the third assembly configured to check integrity of the secondary containment area in response to performing at least one of a plurality of checks,
a first check comprising a vacuum test of the tank wrap, and
a second check comprising a pressure test of the tank wrap.

12. The storage container of claim 11 wherein the third assembly is further configured to check integrity of the tertiary containment area between the first layer and the second layer of the tank wrap in response to a third check comprising a vacuum test of the tank wrap prior to covering the at least a portion of the primary tank with the tank wrap.

13. The storage container of claim 11 wherein the tank wrap is constructed in response to welding at least two sheets of a polyethylene material to create an airtight polyethylene mat.

14. The storage container of claim 11 wherein the tank wrap is constructed in response to forming at least two sheets of rubber to create an airtight rubber mat.

15. The storage container of claim 11 further comprising:
a material situated between the first layer and the second layer of the tank wrap, the material configured to enhance communication within the containment area between the first layer and the second layer of the tank wrap.

16. The storage container of claim 11 wherein the at least a portion of at least one of the first layer and the second layer of the tank wrap is deformed to enhance communication within the containment area between the first layer and the second layer of the tank wrap.

17. The storage container of claim 16 wherein the at least a portion of at least one of the first layer and the second layer of the tank wrap is deformed to include one or more dimples.

18. The storage container of claim 16 wherein the at least a portion of at least one of the first layer and the second layer of the tank wrap is deformed to include one or more ridges.

19. The storage container of claim 11 further comprising:
a secondary tank including one or more layers of concrete encasing the primary tank and the tank wrap.

20. A system for testing secondary containment of a storage container, the device comprising:
one or more leak detection devices configured to detect presence of a liquid or gas within an interstice between a primary tank and at least one of a first layer and a second layer of a tank wrap covering at least a portion of the primary tank; and
one or more testing assemblies configured for checking integrity of the interstice in response to performing at least one of a plurality of separate checks using means for vacuum testing the tank wrap or means for pressure testing the tank wrap subsequent to encasing the primary tank and the tank wrap in one or more layers of concrete.
